(19) United States
(12) Patent Application Publication
(10) Pub. No.: US 2017/0331945 A1
(43) Pub. Date: Nov. 16, 2017

(54) CONDITIONED TRIGGERING OF INTERACTIVE APPLICATIONS

(71) Applicant: DIAL ONCE IP LIMITED, Dublin (IE)

(72) Inventors: Charles DUNSTON, Saint Cloud (FR); Benoit BOUFFARD, Levallois-Perret (FR); Julien KERNEC'H, Paris (FR)

(21) Appl. No.: 15/529,242

(22) PCT Filed: Nov. 24, 2015
(86) PCT No.: PCT/EP2015/077570

§ 371 Date: May 24, 2017

(30) Foreign Application Priority Data
Nov. 27, 2014 (FR) 1461540

(51) Int. Cl. H04M 1/725; H04M 3/42

(52) U.S. Cl. CPC H04M 1/72597; H04M 3/42093; H04M 3/42059; H04M 3/42042; H04M 2203/253; H04M 2203/254

(57) ABSTRACT

The present invention concerns a method, implemented by a telephone terminal in order to trigger an interactive application on recognition of the call number, the method comprising the following steps: the telephone number of a call made to a called number or of a call received from a calling number is compared to a list of predefined numbers; if said current number is present in said list of predefined numbers (110), an interactive application is activated and presented to the user (160), and if, furthermore, the call is an outgoing call (170), the telephone communication corresponding to said outgoing call is inhibited (180).

### FIELD OF INVENTION

The present invention relates to the field of telephony and interactive terminals.

### BACKGROUND

Interactive terminals capable of sending and receiving telephone calls afford a user firstly a rich interactive experience, illustrated by navigating on websites suited to the screen format and to the input/output organs of the terminal, as well as the use of applications loaded in the terminal designed to be ergonomic, and secondly enable them to make and receive telephone calls using solely the audio channels of the terminal, in the same way as a traditional landline telephone.

When the user calls a customer service of a commercial entity, the user is very often dealt with by an interactive voice server (IVS) in which he navigates by means of pressing on the number keys (the ones on the keypad for dialling telephone numbers) or by sending words that the IVS attempts to recognise by means of voice recognition systems. When the user calls an IVS from an interactive terminal, in particular of the smartphone type, no advantages are derived from the capabilities of this type of terminal, in particular capabilities of interaction, computation and communication via a computerised network such as the 3G/4G networks and the internet.

In the same way, when a customer or commercial service calls a user on the call number of an interactive terminal, no advantages are derived from the capabilities of the terminal, whether the user has actually replied to the call or the latter has been missed.

### SUMMARY

The present invention improves this situation.

To this end, the present invention proposes synergy between the interactive terminal and telephone calls, particular outgoing calls to numbers of services normally managed by IVSs as well as incoming calls coming from commercial or professional entities. When the user who sends or receives these calls does so from an interactive terminal, a process executed by the terminal is notified of:
the received calls (incoming calls) at the moment when they are received and before the communication can be established, and
of calls to be sent (outgoing calls) before the terminal actually establishes communication to the called number, and
of the fact that a call is paused, of the fact that a paused call is resumed, of the end of an actual call, of a received call not taken on the terminal and of a sent call not taken by the person called.

The notifications received make it possible among other things to identify the called or calling telephone number. This application can then compare this telephone number with a list of numbers known to it, and evaluate certain necessary predefined context conditions. The predefined context conditions are deemed necessary and are evaluated according to the current context. If all the necessary conditions are satisfied, the application activates and presents to the user an interactive man/machine interface. In the case where the call that has triggered the notification of the event is an outgoing call, the interactive man/machine interface advantageously replaces the IVS, and the communication is not established, although it is still possible for the user to establish it on demand by interacting with the interactive application.

Noticeably the event is notified to the application that processes it and must either transmit it to another process or consume said event. The consumption of such an event is called completion. The process sending the event and the processes previously notified of said event are notified of the fact that the event in question has indeed been consumed (completed) and can thus react to said completion. An event must generally be completed by one of the processes that were notified thereof, thus validating the fact that it has indeed been taken into account and completely processed. Thus an application that requests to be notified of certain types of events relating to telephone calls receives notifications for all the calls. The application that receives such notification uses the characteristics of the event that it was notified of in order to carry out conditional processing operations according to said characteristics and has the possibility of passing said event to another process without completing it, leaving it to another process to do so. Such an application can also complete said event, which will thus not be notified to any other process. The events are therefore notified to the processes before said events are processed by said processes or by the processes to which said events are transmitted subsequently. The processing of the events by the processes is a well-known practice and the details described above are described only to facilitate understanding of the present invention, which uses this mechanism.

Notifications of events relating to telephone calls are known in certain methods on interactive telephone terminals. The most usual of these methods are those that make the connection between a telephone number, called or calling, and a directory entry in order to make it possible to display, instead of or in addition to the telephone number, the name that is associated therewith in the directory entry. One can also cite the systems making it possible to prohibit calls to or from certain numbers (black lists) and those authorising solely calls coming from and going to certain numbers (white lists). Other systems detect calls going to emergency numbers, locate the calling terminal and send text messages of the SMS type to a telephone number associated with the place where the terminal was located at the time of the call.

The advantages afforded by the present invention are of being able to use the interactive and information-processing functionalities of a telephone terminal in order to improve the efficacy of a telephone communication, or even, in certain cases, to completely replace a telephone communication by an interaction with an interactive application.

The present invention then relates to a method used by data-processing means of a telephone terminal in order to trigger an interactive application on recognition of a call number.

The method comprises the following steps:
a current telephone number of a call sent to a called number or of a call received from a calling number is compared with a list of predetermined numbers;
if said current number is present in said list of predetermined numbers, an interactive application is activated and presented to the user via a man/machine interface, and if furthermore the call is an outgoing call, the telephone communication corresponding to said outgoing call is inhibited.

Advantageously, the method thus activates the man/machine interface only when the called number or the calling number is one of the telephone numbers in a list of predetermined numbers. Current number means the called telephone number or the calling telephone number. Activation of the interactive application and presentation of the man/machine interface means the fact of making the latter perceptible to the user. An example of activation is given, without this being restrictive, by the display of a screen page comprising a menu with multiple choices that could be selected by the user. This makes it possible, for example and non-limitatively, to present the interactive interface when the call number is that of a customer service of a company, the displayed interface comprising elements making it possible to interact with web services of the company. Another example of activation and presentation of the interactive application via a man/machine interface is given, without this being limitative, by the presentation of an audio interface solely offering an interface similar to that of a normally distant interactive voice server.

Inhibiting an outgoing call has the effect of completely decorrelating the interface of the interactive application from any interactive voice server that may moreover exist and used when a call is emitted towards the current number from an apparatus not able to activate an interactive application according to the invention. In particular, and without this being limitative, the interface of the interactive application according to the invention can then be completely different from an interface that is a visual transcription of the audio interface of an interactive voice server (often called Visual IVR, standing for visual interactive voice response or visual integrated voice response), said visual transcription repeating, in the form of visual elements, the same menus and choices as those presented by the audio interface on the distant interactive voice server, the user then being able to interact either via the visual interface or via the audio interface. For example, and non-limitatively, the interface of the interactive application activated according to the invention can be designed so as to comprise an element intended for the user to create or display a graphical representation (signature, manuscript mention, choice of colour, etc), which is not allowed by the visual transcriptions of the menus of interactive voice servers. Furthermore, since the outgoing call is inhibited a priori, the interactive application does not have to interact with the distant interactive voice server.

According to one of the embodiments, the interactive application is notified of an event relating to a telephone call, referred to as the current event. This event is one of the following types: incoming call, outgoing call, paused call, resumed call, end of incoming call, end of outgoing call, missed incoming call or missed outgoing call. The application then compares the type of current event with a list of types of predetermined events. If the type of current event is present in said list of types of predetermined events, the interactive application is activated and presented to the user via a man/machine interface.

Advantageously, the method thus activates the man/machine interface only in the case where the triggering event is of one or more predetermined types. This makes possible, for example and without any limitative character, the activation of the interactive interface only if the call is an outgoing call. This also makes it possible for example, without this being restrictive, to present the interactive interface only in the case where the type of event notified belongs to one of two types “end of incoming call” or “end of outgoing call”, in order to present said interactive interface after a communication has actively and effectively been established and ended, the application then offering an interface to a satisfaction enquiry relating to the call that has just ended or to download and install a loaded application.

According to another embodiment, the activation of the interactive application is further dependent on a verification of current conditions from a predetermined list of possible operating context conditions.

Advantageously, the method thus makes the man/machine interface perceptible only in the cases where certain predetermined context conditions are realised at the current moment, that is to say at the moment when the triggering event is notified to the application. The conditions in question may, for example and without any limitative character, be the existence of a connection with an internet data network, actual access to a distant server, the connection of the terminal to a high-speed wireless data network, the connection of the terminal to a wireless telephony network of a given country, the presence of the terminal in a given geographical area, the fact that the configuration of the language of the dialogues of the system of the terminal forms part of a list of predetermined languages, or the fact that the current time is included in a list of time ranges. For illustration and without this having any limitative character, the method according to the invention can thus activate the interactive interface only outside time ranges of opening of a contact service, the interface then proposing other means of communicating with the distant entity, such as email.

According to another embodiment, the interactive application has at least one interface element enabling the user to establish a telephone communication.

Advantageously, this makes it possible to force the sending of a call. The called number may be the one associated with the event that triggered the notification: a user preferring usual interaction during an outgoing call intercepted according to the method then has the possibility of disregarding the interception. The called number may also be any other number, in particular and non-limitatively a number determined according to the navigation of the user in the interactive application or information that he has provided therein.

According to its hardware aspects, the present invention relates to a telephone terminal characterised in that it comprises:
a non-volatile memory module for storing a list of telephone numbers,
a module for recognising an incoming call number and an outgoing call number,
and a processor for:
   comparing a current called telephone number or a current calling telephone number with the list of stored telephone numbers,
   and executing an interactive application activating a man/machine interface presented to the user if said current number is present in said list of predetermined numbers, inhibiting an outgoing call if furthermore the current number is an outgoing call number.

According to another of its aspects, the present invention relates to a computer program, characterised in that it comprises instructions for the implementation of the above method when these instructions are executed by a processor of the above terminal.

FIG. 1 at least among the figures presented hereinafter illustrates an example embodiment of the flow diagram of the general algorithm of such a computer program.

Other architectures may be used for implementing the method described above without however departing from the scope of the present invention provided that the elements of the above terminal are designed to store and execute the instructions of the aforementioned computer program.

By virtue of the present invention, the capabilities of modern terminals are advantageously used to improve or even replace the experience of the user when the called or calling telephone numbers are those of entities with which the user has to interact, in particular, and without this being limitative, by providing various items of information or being switched to a particular interlocutor or service according to details that he has previously provided.

In some of its embodiments, the man/machine interface of the interactive application according to the invention is that of the website of the calling or called entity. In other embodiments, the interactive application according to the invention makes it possible, for example and in no way limitatively, to add events in the diary of the user on the terminal, or entries in the directory of contacts, or to take advantage of the characterisation of the type of event notified. For illustration, and without this being limitative, the man/machine interface of the interactive application according to the invention can be designed so as to be activated if an outgoing or incoming call has been missed in order to propose contacting by electronic messaging a dedicated interlocutor aware of the subject of the call.

In the case of outgoing calls, other advantages are afforded by the present invention, in particular when the call is intended for a service using an interactive voice server IVS. The user thus avoids using the IVS interface, and dispenses with waiting times and any associated communication costs of voice recognition systems, and the experience of his interaction with the called entity is made richer and more ergonomic. What is more, the method according to the invention enables the interactive application to be designed so that the user has the ability of forcing an outgoing call to a called number for which communication has been inhibited, so as to make possible traditional interaction and to allow interactions that require a dialogue with a human operator. Advantageously, numerous requests and demands that otherwise would have been made by interacting with an IVS or a human operator will be resolved without an audio telephone communication actually having been established, in particular, and non-limitatively, requests for details and information or the interactions that are available on the website of the called entity. An entity operating the IVS derives an advantage from the reduction in the number of calls afforded by the present invention as well as the qualification of the calls finally sent when the application has made it possible to collect details useful to said qualification.

The experience of a user receiving or making a telephone call is greatly improved by the present invention, for example, and non-limitatively, in the case where the user calls the customer service of an airline from a smartphone (smartphone under Android for example, without this being limitative); the call is then not actually sent and, instead, the user is presented an interface of the mobile application type on which he can navigate in order to find the details of a flight, a recording, the number of the lost-and-found services in various countries, or even in the country where he is situated, and then call one of these numbers from the interface, follow a case via his reference entered in an appropriate field of the interface, purchase or exchange tickets and use a “call the company” button to interact with the traditional interactive server system or with a human interlocutor.

### BRIEF DESCRIPTION OF THE DRAWINGS

The features of the invention mentioned above, as well as others, will emerge more clearly from a reading of the following description of example embodiments, said description being given in relation to the accompanying drawings, among which:

FIG. 1 is a flow diagram illustrating various steps of a method of activating an interactive application on recognition of a call number, explaining particularly the steps relating to the process flow for the notified event,

FIG. 2 is a flow diagram illustrating various steps implemented when the user clicks on an element of the interface of the interactive application, said element making it possible to send a telephone call,

FIG. 3 is flow diagram illustrating some of the steps implemented in an application of the method according to the invention, the purpose of which is to replace an outgoing call to an interactive voice server with voice messaging,

FIG. 4 contains examples of interactive interfaces when the telephony terminal is a smartphone used by the Android system,

FIG. 5 is a flow diagram illustrating the principles corresponding to the steps of the method according to the invention implemented in the case where the terminal is a smartphone, and

FIG. 6 illustrates highly schematically a terminal within the meaning of the invention.

### DESCRIPTION OF EMBODIMENTS

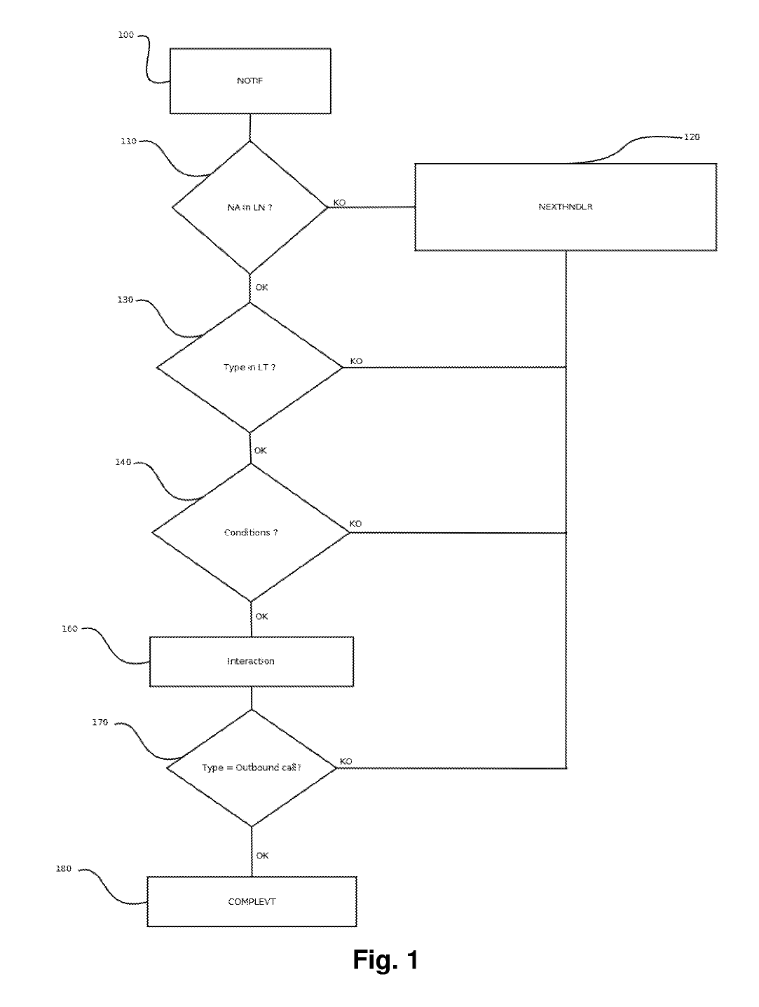

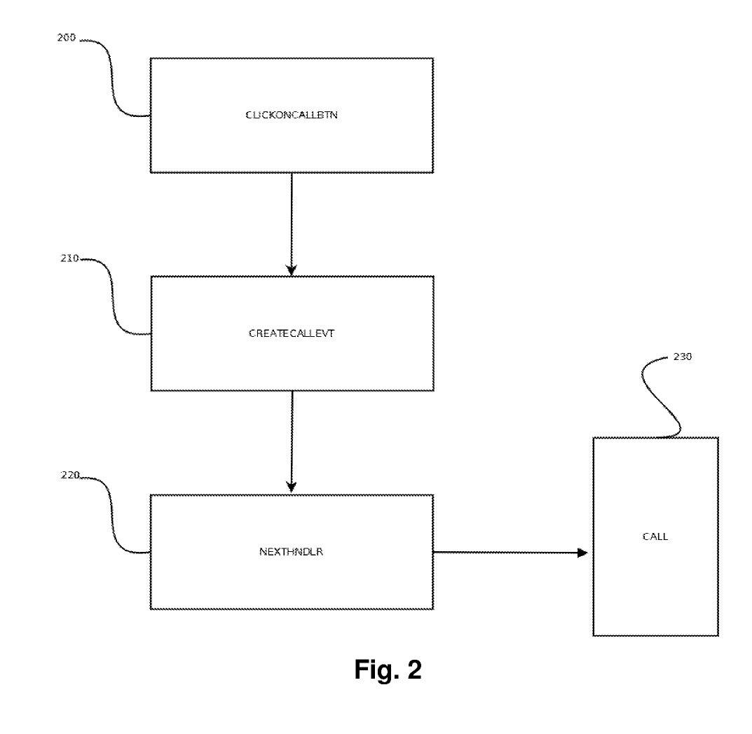

With reference to FIG. 1:
At step 100: on a telephone terminal, a process, also referred to as an interactive application, is notified of events relating to the telephone calls sent or received by the terminal; in a particular instance of the method, the process is notified of an event E, also referred to as the current event. The event E in question enables the process to have knowledge of the telephone number NA associated with the call, also referred to as the current telephone number. The event E also enables the process to access the type of event E, among the following types: incoming call, outgoing call, paused call, resumed call, end of incoming call, end of outgoing call, missed incoming call, missed outgoing call. The data structures associated with the event E comprise a field containing the telephone number NA and a field for identifying the type of event.
At step 120, the event E is transmitted to the telephone communication management interface TCMI of the terminal, which processes it. The event is consumed and completed by the TCMI at this step. This allows normal processing for calls, in particular with the interface habitual to the user, thus giving the possibility for example, and without any constraining character, of taking or rejecting a received call, send a dialled call and pausing or resuming a current call.
At step 110: the process makes a comparison of the number NA with a list of predetermined numbers LN stored in the non-volatile memory of the terminal; this makes it possible to activate the interactive application and to present the man/machine interface solely for certain pre-identified telephone numbers, in particular, but without any limitative character, for the numbers of customer services or contact services of businesses and organisations. If the number NA is not one of those in the list LN, the event E is transmitted to the telephone communication management interface TCMI of the terminal and step 120 is executed. This, if the called or calling telephone number is not one of those to be taken into account, allows normal processing of the calls.
At step 130: the number NA is one of those in the list LN. The process determines whether the type of event E belongs to a non-empty list LT of predetermined event types; this makes it possible to differentiate the cases. In particular, this makes it possible to process only certain types of event. If the type of event E does not belong to the list LT, step 120 is executed, which causes the normal processing of the event, offering to the user the normal telephone call management interface. This makes it possible to present the man/machine interface of the interactive application only in the case where the triggering event is of one or more predetermined types. This, for example and without any limitative character, allows the presentation of the interactive interface only if the call is an outgoing call. This also makes it possible for example, without any limitative character, to present the interactive interface only in the case where the type of event notified is one of the two types “end of incoming call” or “end of outgoing call”, in order to present said interactive interface after a communication has actively and effectively been established and ended, the application then offering an interface to a satisfaction inquiry relating to the call that has just ended.
At step 130: the number NA is in the list of numbers LN and the type of event E is in the list of event types LT. The process determines whether a set of conditions, also referred to as current conditions, is satisfied. The current conditions are evaluated at the time of notification of the event. The current conditions to be evaluated are those in a predetermined list LC of context conditions CN (standing for conditions necessary). The list LC may be empty. Each condition CN present in the list LC is evaluated according to the current context. This makes possible, for example and without any limitative character, to evaluate, at the present moment, a condition CN in the list LC specified such as “the apparatus has a connection to the internet”. Without this having a limitative character, the most usual context conditions are the following: the existence of a connection to an internet data network, the existence of a connection to a high-speed wireless data network, the fact that the system interface of the terminal uses a given language, the fact that the terminal is situated in a given country or geographical area, the fact that the current time lies in a certain set of time ranges; other context conditions and combinations of context conditions may exist according to the various specificities of the application in question. The evaluation of each condition of the list LC makes it possible to activate the interactive interface only under certain conditions. If at least one of the current conditions present in the list LC is not satisfied, step 120 is executed, resulting in a standard processing and an experience of the user similar to that experienced using a conventional telephone terminal, in particular a landline.
At step 160: the number NA belongs to the list of numbers to be taken into account, the type of event E forms part of the types to be taken into account, and all the necessary conditions are satisfied. The interactive application then presents to the user a man/machine interface; this interface may be unique or differ according to the type of event notified. In particular, and without this have a limitative character, this interface may be the one presented by the terminal when the user navigates on the website of the calling or called entity; the interface may also be more specific and in particular may be that of an application loaded on the terminal, said application taking advantage of the type of event E.
At step 170: the process determines whether the type of event E is of the “outgoing call” type. If such is the case, step 180 is executed and the event E is consumed and completed. The event E is then not transmitted to the TCMI module of the terminal, which has the effect that the audio communication is not actually established between the terminal and the subscriber to whom the call number NA belongs. In particular, and non-limitatively, in the cases where the telephone communication with the called number is processed by an IVS, the user then prevents navigation on the IVS of the called entity. If the type of event E is not “outgoing call”, then step 120 is executed. This enables the user to use the normal telephone interface, in particular and non-limitatively, in order to be able to reply to or reject a call.
   With reference now to FIG. 2:
At step 200, the interactive application is notified of an event characterising the fact that the user has activated an element of the interactive interface intended to initiate the sending of a telephone call. For example and non-limitatively, this event may be generated after the user has pressed an element of the button type of an interface of the touch-screen type, said button-type element containing the text “Call the customer service”.
At step 210, the application invokes the creation of an event OC. The event OC is created with the type of event “outgoing call”. A call number is associated with the event OC.
At step 220, the application transmits the event OC to the telephone communication management interface TCMI of the terminal that is processing said event. The event is consumed and completed by the TCMI at this step. This allows normal processing of the call.
At step 230, the normal call management interface is activated, thus giving the possibility for the user, for example and without any constraining character, to pause, resume and terminate the call sent.

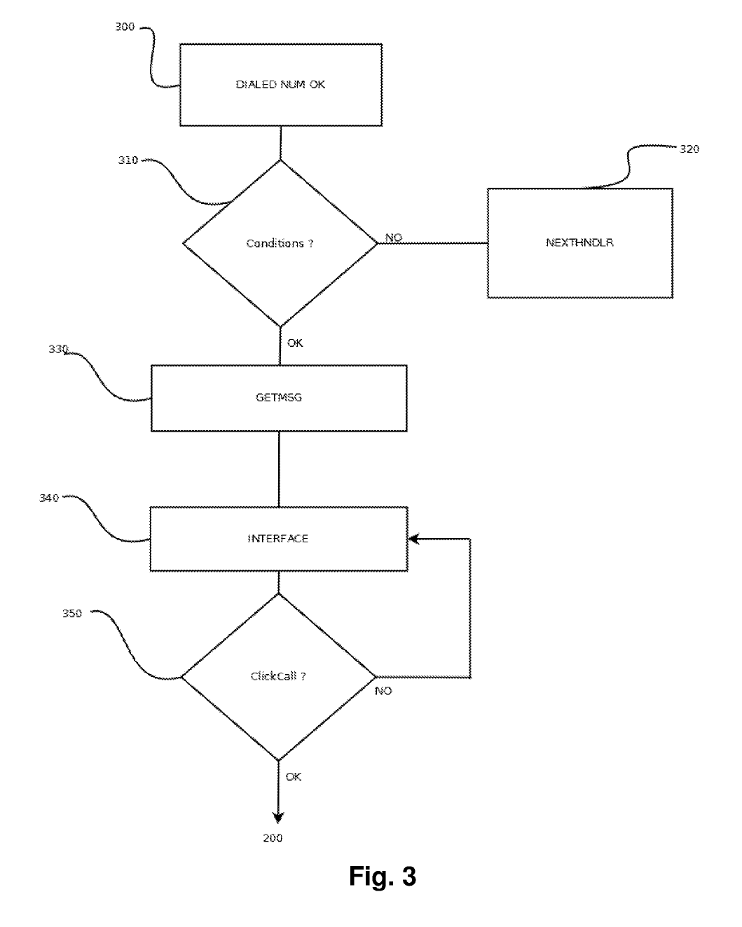

FIG. 3 illustrates some of the steps deemed to be relevant for an understanding of the present invention, steps implemented in an application of the method according to the invention, the purpose of which is to replace, by an interactive man/machine interface, a call sent to the voice messaging of the mobile telephony operator SFR. The subscribers of this mobile telephony operator dial the number 123 in order to access their voice messaging. The latter offers an interface of the interactive voice server type in which, among other things, pressing the key 1 makes it possible to listen to the archived messages in the chronological order of their recording and pressing the key 2 makes it possible to listen to new messages. The subscribers of this operator also have the possibility of using the IMAP (internet message access protocol) in order to have access to the recording of voice messages of their voice messaging in the form of emails, said recordings then being provided in the form of documents attached to said emails.

Step 300 of this figure corresponds to the start of step 140 of FIG. 1, the call number having been compared positively with the prerecorded number 123 and the type of event notified being “outgoing call”. At step 310, the application satisfies the following conditions:
One of the following three conditions is satisfied: the terminal is connected to an internet network via WiFi, the terminal is connected to the internet via a 3G data network, the terminal is connected to the internet via a 4G data network
The application can initiate a connection to the distant server imap.sfr.fr via the IMAP protocol using the identifiers and passwords of the user, previously given and recorded.

If at least one of these two conditions is not satisfied, the call is passed normally to the number 123, which is shown schematically by step 320, in every respect similar to step 120 in FIG. 1. Thus, in the case where it is not possible to effectively interact, through lack of connectivity or bandwidth, with the server imap.sfr.fr, the call to the number 123 is effectively passed and the user then uses the IVS of the voice messaging.

If the previous two conditions are satisfied, step 330 is implemented:
The application establishes the connection to the server imap.sfr.fr using the IMAP protocol and the identifiers and passwords of the user previously given and recorded.
The IMAP protocol is used to recover the list of available emails.
The application selects, from said list of available emails, those containing voice-message recordings. To do this, the application identifies the emails where the subject begins with the keywords “Voice Message from”. An email the subject of which is “Voice Message from 0102030405 received on 24/11/2014 at 17.53” would thus be selected.
   At step 340:
The application displays the list of emails thus selected in reverse chronological order.
The application enables the user to select the subject of an email thus displayed and then to listen to the voice message that is attached thereto using an interface element provided for this purpose. When the user activates said interface element, the application uses IMAP protocol to recover the email the subject of which was selected and extracts from the items attached to the email the voice message recorded in the form of an MP3 audio file to enable it to be listened to.
The application enables the user to select a plurality of messages in order to delete them.

The application also enables the user to call the telephone number of the sender of a recorded message, extracting said telephone number from the subject of the email. The detection of the fact that the user has triggered the call to said telephone number is illustrated by step 350. When this detection has taken place, the application initiates the outgoing call as described previously and illustrated in FIG. 2, which is shown schematically by the link between step 350 and step 200.

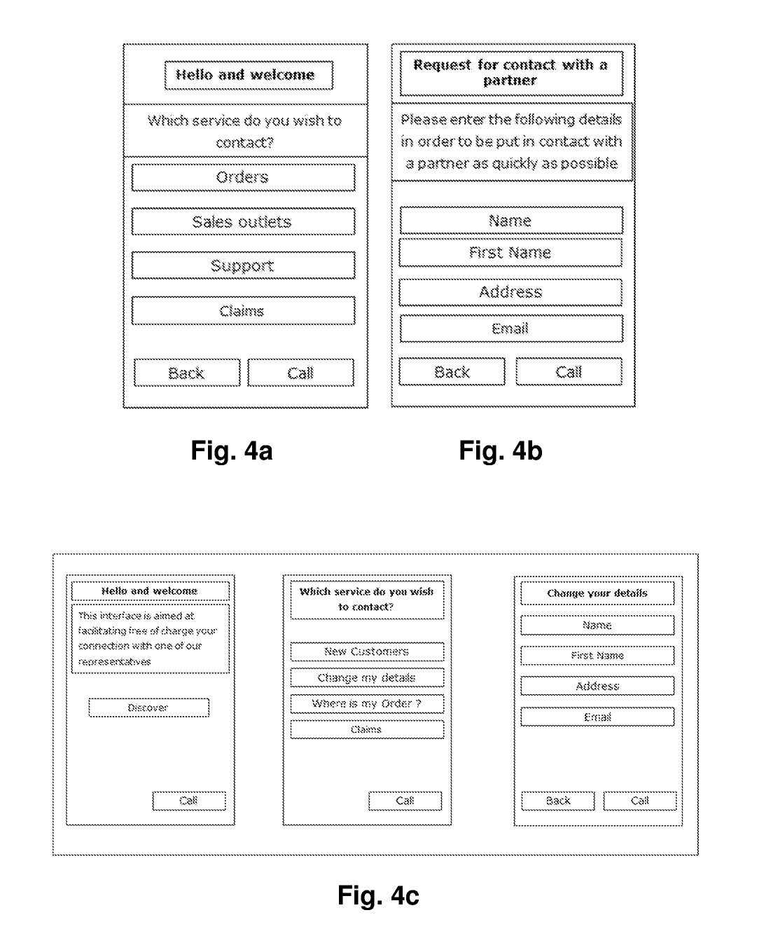

FIG. 4a illustrates an example of an interactive man/machine interface presented on a telephone terminal used by the Android system. This interface is presented at the time of interception of an outgoing call to a telephone number of a customer service putting the user in contact with an interactive voice server. This interface is presented instead of the sending of the call. The field containing the text “Call” enables the user to send a telephone call to the telephone dialled by the user and the interception of which triggered the activation and the application and the presentation of the interactive man/machine interface.

FIG. 4b illustrates an example of an interactive man/machine interface presented on a terminal used by the Android system when the interactions of the user with the interactive application result in the latter displaying an interactive interface requesting contact with a partner. The area where the text “Call” appears enables the user to establish a telephone call to a telephone number, the latter being able to be predefined or supplied dynamically by the interactive application according to the current context.

FIG. 4c illustrates examples of interactive man/machine interfaces presented on a terminal used by the Android system when an outgoing call is intercepted. The area where the text “Call” appears enables the user to establish a telephone call to a telephone number, the latter being able to be predefined, for example the number initially dialled, or supplied dynamically by the interactive application according to the current context.

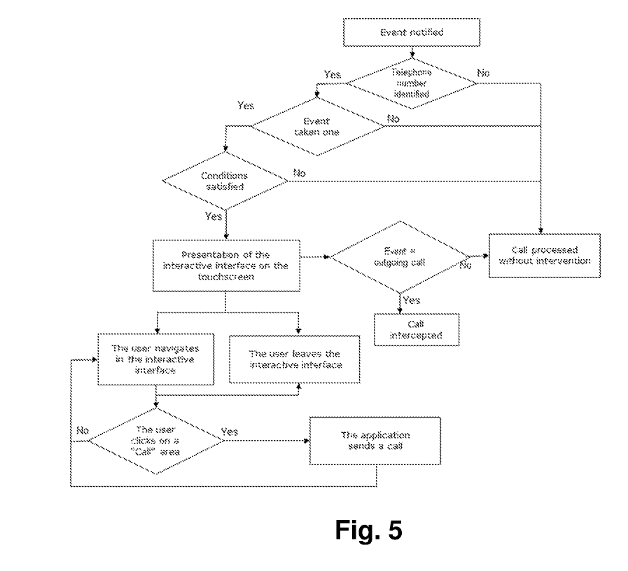

FIG. 5 illustrates the concatenation of the steps of a particular embodiment of the method according to the invention when the telephone terminal is a smartphone and the interactive interface is used as a touchscreen of the terminal to interact with the user.

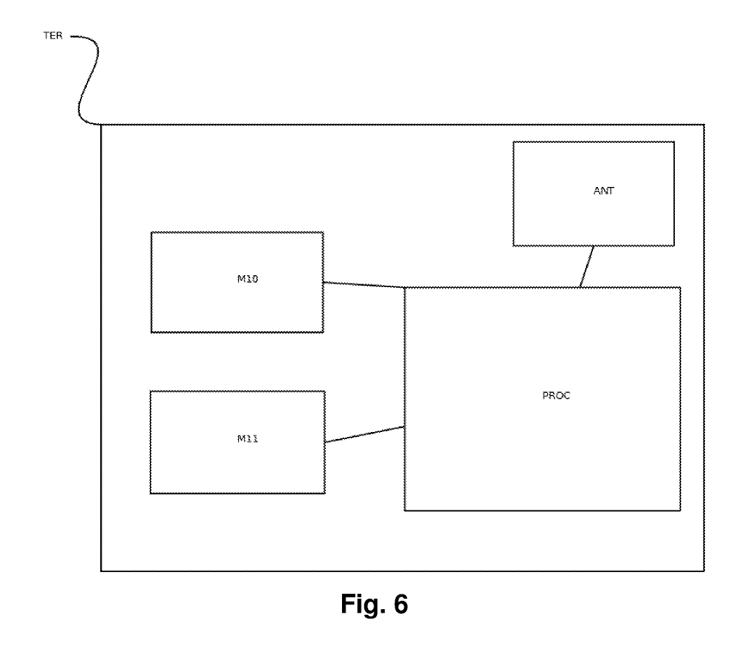

Finally, FIG. 6 shows a telephone terminal TER comprising, within the meaning of the invention:
antenna means ANT for sending or receiving calls,
a non-volatile memory module M10 for storing a list of telephone numbers,
a module M11 for recognising incoming call numbers and outgoing call numbers,
and a processor PROC for:
   comparing a current called telephone number or a current calling telephone number with the list of stored telephone numbers,
   and executing an interactive application activating a man/machine interface presented to the user if said current number is present in said list of predetermined numbers, inhibiting an outgoing call if furthermore the current number is an outgoing call number.

Naturally the present invention is not limited to the example embodiments below: it extents to other variants.

Thus, for example, account is taken in the example embodiment presented here both of the call number and of the type of event notified. Nevertheless, it will be understood that at least one of these parameters such as the call number is already suitable by itself for deciding on an activation of the interactive application within the meaning of the invention.

1. Method implemented by computing means of a telephone terminal for the activation of an interactive application on recognition of a call number, said terminal being configured to emit and receive audio calls and to animate and present interactive applications, the method comprising the steps in which:
a current telephone number of a call sent to a called number or of a call received from a calling number is compared with a list of predetermined numbers,
if said current number is present in said list of predetermined numbers (110), an interactive application is activated and presented to the user (160), and if furthermore the call is an outgoing call (170) the telephone communication corresponding to said outgoing call is inhibited (180).

2. Method according to claim 1, comprising the steps in which:
said interactive application is notified of a current event (100) of the type: incoming call, outgoing call, paused call, resumed call, end of incoming call, end of outgoing call, missed incoming call or missed outgoing call,
the type of said current event notified to said application is compared with a list of predetermined event types,
if said type of current event notified is present in said list of predetermined event types (130), the interactive application is activated and presented to the user via a man/machine interface (160).

3. Method according to claim 1, comprising a step in which:
the activation of said interactive application is also dependent on a verification of current conditions from a predetermined list of possible operating context conditions (140).

4. Method according to claim 1, characterised in that:
said interactive application has at least one interface element enabling the user to establish a telephone communication (200).

5. Telephone terminal, characterised in that it comprises:
a non-volatile memory module for storing a list of telephone numbers,
a module for recognising an incoming call number and an outgoing call number,
and a processor for:
comparing a current called telephone number or a current calling telephone number with the list of stored telephone numbers,
and executing an interactive application activating a man/machine interface presented to the user if said current number is present in said list of predetermined numbers, inhibiting an outgoing call if furthermore the current number is an outgoing call number.

6. Computer program, characterised in that it contains instructions for implementing the method according to claim 1, when these instructions are executed by a processor.
